(19) United States
(12) Patent Application Publication
(10) Pub. No.: US 2023/0359926 A1
(43) Pub. Date: Nov. 9, 2023

(54) DOMAIN ADAPTATION OF EVENT DETECTION MODELS: FROM SIMULATION TO LARGE SCALE LOGISTICS ENVIRONMENTS

(71) Applicant: Dell Products L.P., Round Rock, TX (US)

(72) Inventors: Pablo Nascimento da Silva, Niteroi (BR); Vinicius Michel Gottin, Rio de Janeiro (BR); Paulo Abelha Ferreira, Rio de Janeiro (BR)

(21) Appl. No.: 17/662,470

(22) Filed: May 9, 2022

(51) Int. Cl. G06N 20/00; G05B 23/02; G05B 17/02

(52) U.S. Cl. CPC G06N 20/00; G05B 23/0243; G05B 17/02

(57) ABSTRACT

One example method includes collecting data regarding operations of equipment in an operating environment, using the collected data to create simulated data, using the simulated data to build a model that is operable to detect an event of interest that relates to the equipment, using the collected data to refine the model, and applying the model in a target environment, wherein applying the model includes deploying the model to equipment operating in a target environment.

### FIELD OF THE INVENTION

Embodiments of the present invention generally relate to event detection ML (machine learning) models. More particularly, at least some embodiments of the invention relate to systems, hardware, software, computer-readable media, and methods for adapting an ML model built and trained in a simulated environment to a large-scale, real world, environment.

### BACKGROUND

A significant problem in the area of the construction and use of ML models is the lack of labeled data to build a supervised machine learning model to detect events. Acquiring the ground truth of events is typically not feasible both due to the volume of data that is needed, as well as, typically, the risks that may be involved in collecting data in real environments, particularly regarding hazardous events.

In more detail, the unsupervised learning of dangerous behavior detection models presents particular challenges concerning the lack of labeled data to build a supervised machine learning model to detect and flag potentially dangerous events. It is widely known that machine learning models may present a compelling approach to the solution of a large variety of problems. However, for supervised learning models, this is particularly true regarding domains with abundant labeled data. In the domain, for example, of forklifts operating inside a warehouse, where a goal of the machine learning model may be to trigger alarms upon detection of dangerous driving behaviors such as excessive speed cornering, collecting the needed data can be quite a challenge. It is not reasonable to expose the driver to bad or unsafe conditions in order to collect complex events data to build the model. Thus, data collection and, more specifically, data labeling, may be a significant problem in this domain.

Given the problems known to exist regarding collection of useful data for model building, attention has been directed to the leveraging of simulation data. An advantage of simulation may be automatically labeled data can be readily obtained, as events can be generated on demand. Further, the data generation does not require, for example, exposure of a driver or operator to unsafe conditions.

However, leveraging previously collected data to produce a simulation environment is not straightforward. This is a challenge because the real environments constraints must be respected in the simulation. Thus, efficient approaches for building a fitting simulation are desirable.

A further challenge is that the simulation may include biases, or represent cases that are feasible in the actual domain. This is related to the typical tradeoff between fitness, that is, the capacity of the model to represent known behavior, precision, that is, the model should represent only feasible behavior, and generality, that is, representing feasible behavior that is not known a priori. Because of that, it may be assumed that once labeled data is collected in any environment, whether simulated or real, the application domain for the model ultimately generated can be somewhat different and, as such, the accuracy of the learned model can be impacted. Thus, it may be challenging to adapt a model to a different domain, that is, a domain that is different from the one in which the model was generated and/or trained, without requiring or using labeled data, such as labeled data that represents a target environment for use of the model.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses the collection of sensors readings from an example edge device.

FIG. 2 discloses aspects of a process for training an ML model at a near-edge node, and deployment of the trained ML model to an edge node.

FIG. 3 discloses an overview of a DANN such as may be employed in example embodiments.

FIG. 4 discloses an example simulation ML model generated at a near-edge node.

FIG. 5 discloses the training of an example event detection module using supervised learning, and adaptation of the event detection model to real world data.

FIG. 6 discloses an example method, according to some embodiments.

FIG. 7 discloses an example computing entity operable to perform any of the claimed methods, processes, and operations.

### DETAILED DESCRIPTION OF SOME EXAMPLE EMBODIMENTS

Embodiments of the present invention generally relate to event detection ML (machine learning) models. More particularly, at least some embodiments of the invention relate to systems, hardware, software, computer-readable media, and methods for adapting an ML model built and trained in a simulated environment to a large-scale, real world, environment. The real world environment may, or may not, be the same as the simulated environment that was the basis for the construction and training of the ML model.

In general, example embodiments of the invention are concerned with the domain of automation and management support at on-premise edge environments, one non-limiting example of which is logistics warehouses where materials are stored. Some example embodiments may thus comprise forklifts as mobile, far-edge, or simply ‘edge,’ devices, and may also comprise a near-edge, on-premise, central node operable to communicate with the edge nodes. Embodiments may provide for event detection from sensor streams by way of machine learning models. In one example implementation, a sensor may comprise a video camera that is mounted to mobile equipment, such as a forklift, and that is operable to gather data, namely, video, regarding the forklift and its operation, as well as the environment within which the forklift operates.

Some particular embodiments are directed to a method for simulating, based on previously collected data, forklift trajectories and behaviors in a virtual environment. Among other things, example methods may operate to collect labeled data of hazardous events. Then, embodiments may use the data collected in the simulation to build a supervised machine learning model that is operable to predict events, such as in a domain to which the ML model may be deployed. As well, example embodiments may involve the application of a domain adaptation method to adapt the model from the virtual environment, where the training data was collected, to a real environment which may or may not be the same as the simulated environment. Note that as used herein, ‘labeled’ data includes data that has been annotated, possibly by a human, with one or more labels that explain the nature of the data.

Thus, example embodiments may provide a method for leveraging simulated data for supervised learning of event detection models in edge environments. Further, example embodiments may also implement the fitting and generalization of such models using domain adaptation approaches.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may obtain data for training an event detection model, while avoiding the need to subject personnel to hazardous conditions for data collection processes. An embodiment may generalize, or adapt, a model trained in a simulation environment to be operable in a real world environment. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Environments such as warehouses hold stock, but present a variety of hazards for personnel, such as equipment operators. For example, forklifts are subject to potentially dangerous scenarios when dealing with heavy equipment, carrying pallets, and moving fast. Hence, safety concerns in forklift operations may be important to warehouses and other, large-scale, logistics domains. With the integration of motion and positioning sensors to forklifts, the warehouse may become a prime example of a dynamic edge environment in which quickness and accuracy in decision-making are paramount. Sensors, such as video cameras for example, implemented on equipment such as forklifts may then be used to improve the security of the operators by triggering alarms when the behavior of the forklifts is erroneous or dangerous. That is, the sensors, in cooperation with an ML model deployed on the forklifts, may detect such behavior, and the model may generate a prediction as to the expected result of such behavior if the behavior is not changed in a timely and effective way. The prediction may be conveyed to the operator in various ways, such as through the use of warning lights and/or audible warnings and signals.

Thus, some example embodiments are directed to a machine learning system for generating alerts to forklift drivers when the model detects anomalous behavior by the driver, such as excessive speed when turning a corner with the forklift. Such an alert may indicate to the operator that if corrective action is not taken, a crash or other event may occur. An anomalous cornering event may be defined, for example, as an event where the forklift trajectory and its sensor(s) readings, such as acceleration, cornering angle, mast height, and/or load, for example, differs from ordinary operational behavior or standards.

One of the main issues, which may be addressed by some embodiments, in developing a machine learning model to address the problem of anomalous equipment operation, or other anomalous operations, or operations of interest, is the lack of labeled data, preventing the application of supervised learning approaches, which may be most efficient. To build a machine learning model capable of differentiating regular from anomalous cornering events, supervised learning approaches would likely require the collection of trajectories, that is, movements in a three-dimensional space, and sensor reading data from both types of events. For various reasons however, this is not typically possible. First, dangerous cornering events, or other anomalous operating events, may be exceedingly rare in the domain. Second, it is unfeasible to ask an operator to carelessly drive the forklifts or other equipment in order to enable the collection of anomalous events in a controlled environment. Furthermore, even if dangerous cornering events were to be captured in the actual operations, those events may not be labeled as such.

Thus, example embodiments may operate to rely on previously collected sensor data to build a simulator, such as a forklift trajectories simulator for example. This process may be supported and/or guided by expert knowledge, as well, based on detailed physical formulations, if/when those are available.

In more detail, a simulator according to some example embodiments may be helpful to generate synthetic data, while providing very high levels of introspection, that is, introspective inquiry as to why a particular decision was made by the simulator or model, and/or how a particular problem was solved by the simulator or model. The simulation allows the generation of anomalous behavior, such as dangerous cornering events in the example of forklifts operating in a warehouse, in a controlled environment and, regardless of the internal representations and physical formulations the simulation considers, the simulation may be able to represent those events with respect to the sensor signals that are deployed in the domain.

Hence, embodiments may operate to leverage the simulated data to build a powerful supervised machine learning model to detect dangerous cornering events. It is noted, however, that machine learning models developed with simulated data may be inaccurate due to mismatches and over-generalizations in the simulation model itself. Thus, in order to be able to accurately and reliably detect anomalous events, and predict the outcomes of such events, more may be required beyond simply the development of the ML model. To reduce the possible inaccuracy of simulation models, embodiments may provide a method to leverage actual data collected at the warehouse, which may constitute an edge computing environment, to fine tune the supervised model that has been developed using simulated data. More concretely, example embodiments may operate adapt a simulation model, that was trained with simulated data, using a transfer learning domain adaptation procedure.

### B. Aspects of Example Environments

The following is a discussion of some aspects of example operating environments for various embodiments of the invention. This discussion is not intended to limit the scope of the invention, or the applicability of the embodiments, in any way.

### B.1 Sensor Data Collection

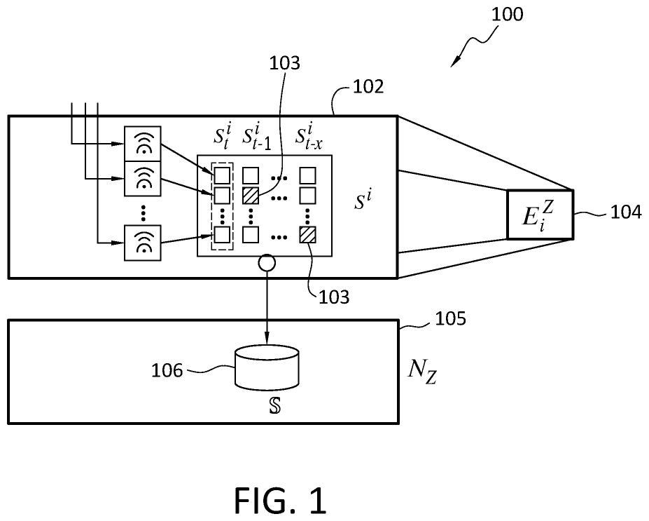

Example embodiments may assume, again applying the non-limiting example of forklift operations in a warehouse, data collected at the near edge from sensors such as video cameras deployed at each edge device, that is, forklift, individually. Each forklift may comprise several sensors and collect, over time, multiple readings into a combined sensor stream. This is shown in FIG. 1. Particularly, FIG. 1 discloses an example configuration 100 in which a collection 102 of sensor readings Si from a forklift Ez 104 is added to a near-edge Nz node 105 database 106 of sensor readings [symbol] . FIG. 1 represents distinct sensors at forklift Ei whose readings are aggregated into a sensor stream Si of one or more collections Sₜⁱ, Sₜ₋₁ⁱ, Sₜ₋₂ⁱ . . . that may each be taken at a different respective time ‘t.’

As depicted in FIG. 1, embodiments may assume collection of sensor readings can be correlated among themselves. For example, an embodiment may use GPS data as well as some RFID location data so while these two different readings may be taken by different sensors, the readings may be highly correlated with each other insofar as they are indicative of a location of an edge node, such as a forklift for example. It is noted that a collection of sensor readings may be triggered periodically, or by a change in values, such as triggering a collection of readings every time an acceleration or deceleration is observed for example, or a combination of both. The collection st is the most recent collection at time instant t. In this context, an embodiment may assume at least x previous collections of sensor readings are stored within the edge node 104.

Some sensor reading collections may not contain valid readings for certain sensors, as shown by the shaded sensors 103 in FIG. 1. For example, even if a sensor is operating properly, it may take an erroneous reading in certain circumstances. To illustrate, a GPS sensor may not be able to detect, or may incorrectly detect, the position of a piece of equipment when that equipment is in a space enclosed by concrete or metal.

Example sensor reading collections may comprise valid positioning data that may be mapped into the coordinates of an environment, where such positioning data may comprise, for example, GPS measurements in a warehouse, WiFi triangulation, and RFID positioning. Additional information may comprise inertial measurements of acceleration and deceleration such as may be obtained by an inertial measurement unit (IMU), as well as bearing, that is, direction, and other kinds of rich movement tracking such as, for example, forklift mast position, and load weight.

### B.2 Event Detection Model Training and Inference at the Edge

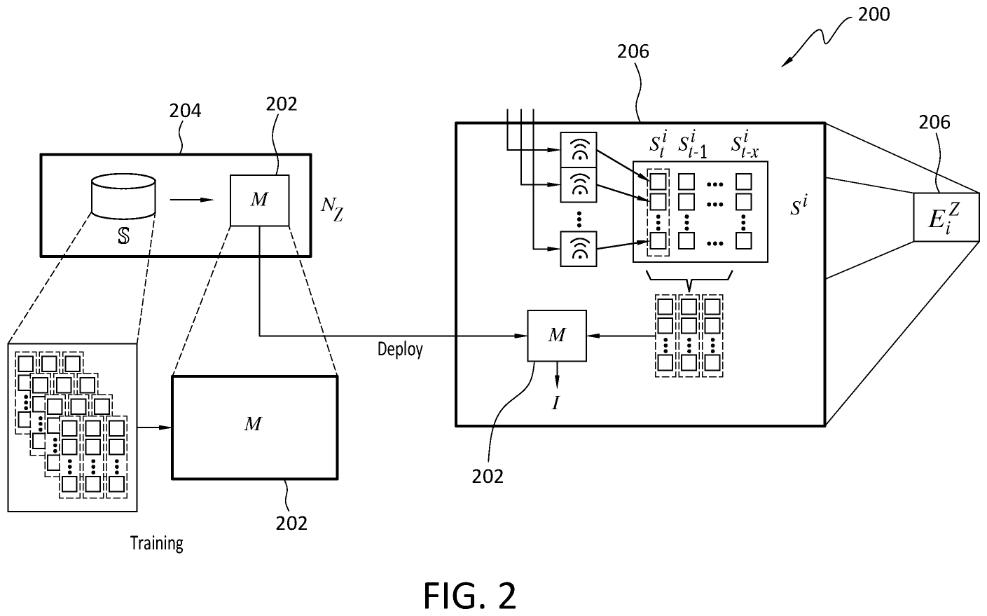

With continued reference to the warehouse/forklift illustrative example, the collections of sensor readings may be used at the forklift itself for decision making but may also eventually be collected at a near edge node. One approach for relying on machine learning may comprise the training of an ML model at a near edge node. This is depicted in the configuration 200 of FIG. 2 which discloses, in particular, the training of an ML model 202 at a near-edge node 204, and the deployment of the resulting ML model 202 at one or more edge nodes 206 of an edge environment.

Leveraging the sensor collections most recently collected, the inference I of the ML model 202 may be used for decision making in very quick fashion, that is, with very little delay after the ML model 202 has detected an event of interest. That is, an application for the ML model 202 may be to perform event detection. For example, the ML model M 202 may be trained to provide as inference I an indication of events of interest. Notice that several models may be trained and deployed in a similar fashion concurrently. That is, an edge node may have instances of multiple different models installed and running on it.

The training of neural network (NN) machine learning models, such as the ML model 202 for example, may rely in whole or in part on training algorithms, which may be supported by optimization. This situation may be the same for deep neural networks (DNN), which may rely on the backpropagation algorithm and an optimization algorithm, such as the Stochastic Gradient Descent (SGD) optimization algorithm for example.

Before initialization of a NN, a network topology of neurons and interconnecting weights may be chosen. This topology may determine how the calculations will flow through the NN. After that, an initialization may be performed, which will set the weight values to some random, or predefined, values. Finally, the training algorithm may separate batches of data and flow those batches of data through the DNN. Afterward, one step of backpropagation occurs, which may set the direction of movement of each of the weights through the gradients. Finally, the weights may change by a small amount, ruled by the algorithm learning rate. This process may go on for as many batches as necessary until all training data has been consumed by the model that is being trained. This greater iteration may be referred to as an ‘epoch.’ The training may go on until a predefined number of epochs is reached, or any other criteria are met, for example, no significant improvement in performance of the model was observed over the last ‘p’ epochs.

B.3 Domain Adversarial Neural Network (DANN)

Domain Adaptation (DA) is a type of transfer learning where the source and target tasks are the same, but there is a shift between source domain and target domain distributions. The shift between the two domains means that the model for the source domain has a decrease in the accuracy when it is applied on a new unseen target domain. There may be a significant challenge in performing this type of adaptation, since the neural network requires large amounts of labeled data for training.

One example Domain Adversarial Neural Network (DANN) borrows the concept of adversarial training to adapt a neural network to a new domain, using a combination of labeled data and unlabeled data. This may make the adaptation process more feasible, since there is no need for labeling data during the adaptation procedure. This characteristic may be useful in domains relating to example embodiments of the invention.

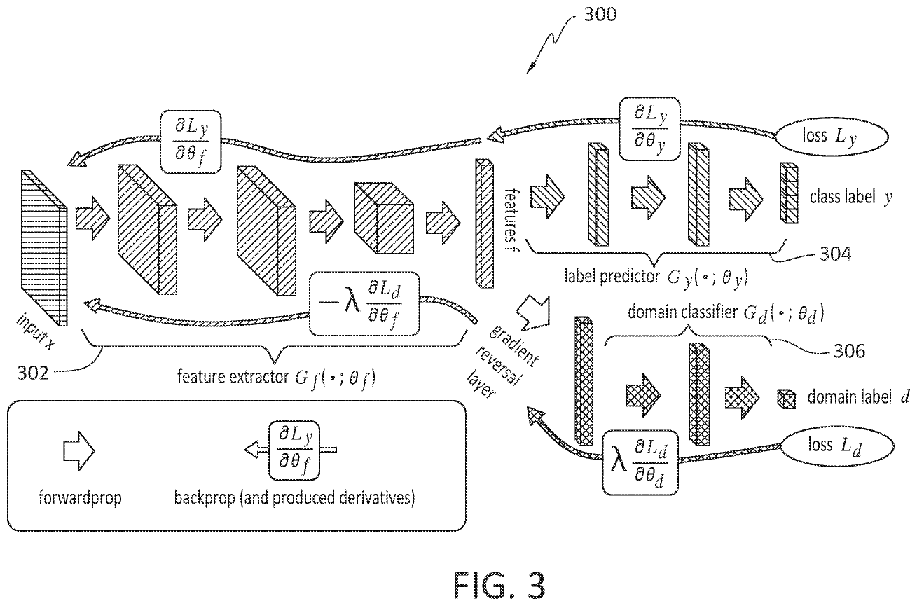

As shown in FIG. 3, which provides an overview of the Domain Adversarial Neural Network (DANN) model that may be used in some example embodiments, an example DANN model 300 may comprise three parts, namely: (i) a feature extractor 302 that learns how to extract features that are discriminative and invariant between the source and target domains; (ii) a label predictor 304, which may be responsible to perform image segmentation in some example embodiments, and which may be trained only on labeled data; and (iii) a domain classifier 306, which may be responsible to learn which image(s) comes from the source domain (labeled data) and which image(s) comes from the target domain (unlabeled data, such as sensor data collected, for example, by a forklift in an operating environment such as a warehouse). This information may be used to improve the feature extractor. Training this part of the model may require labeled data from the source, and may also require unlabeled data collected by the vehicle.

Given the example DANN model 300 of FIG. 3, the corresponding prediction loss and the domain loss may be determined as follows, respectively:

L_{y}ⁱ(θ_{f},θ_{y})=L_{y}(G_{y}(G_{f}(xᵢ;θ_{f});θ_{y}),yᵢ)

L_{d}ⁱ(θ_{f},θ_{d})=L_{y}(G_{d}(G_{f}(xᵢ;θ_{f});θ_{d}),dᵢ)

where G(x, θ) is a neural network applied to a dataset x with parameters θ, yᵢ is the correct label of instance xᵢ, and dᵢ is the correct domain label of instance xᵢ.

Thus, training the example DANN model 300 may comprise optimizing the following function:

$$E ( {θ}_{f} , {θ}_{y} , {θ}_{d} ) = \frac{1}{n} {\sum }_{i = 1}^{n} {L}_{y}^{i} ( {θ}_{f} , {θ}_{y} ) - λ ( \frac{1}{n} {L}_{d}^{i} ( {θ}_{f} , {θ}_{d} ) + \frac{1}{{n}^{′}} {L}_{d}^{i} ( {θ}_{f} , {θ}_{d} ) )$$

where n is the number of instances in the source dataset, and n′ is the number of instances in the target dataset. It may be the case that n′>>n. Note that, in this illustrative case, the function (immediately above) that is optimized may be calculated over two distinct datasets with different respective sizes.

### C. Aspects of Some Example Embodiments

### C.1 Overview

Example embodiments may implement an approach to apply a domain adaptation technique so that a model trained with simulated data can be effectively applied to the real-world case, for which there may be no available labeled data. In general, example embodiments may include at least two elements, namely: (i) simulation and model building; and, (ii) deployment and model adaptation. These are discussed below.

The simulation and model building element (i) may involve collecting data from real world environments, such as warehouses for example. The data may be generated and/or collected by one or more sensors, such as a video camera for example, operating in the environment. Then, the collected data may be used to build a simulation tool to manipulate the collected data to synthetically create data, that is, simulated data, representing situations in which dangerous events occur. By repeating this replay process, possibly a large number of times, embodiments may collect a large amount of simulated, labeled, data, that is, data points representing dangerous cornerings. Thus, example embodiments may operate to construct a machine learning model, such as a DNN for example, using a traditional supervised learning method, to predict the occurrence of events of interest, such as dangerous cornering events in the context of the warehouse example.

The deploy and model adaptation (ii) may involve collecting real, but unlabeled, data from edge nodes, such as the forklifts inside a target warehouse. Embodiments may then apply a transfer learning methodology of domain adaptation to adapt the previously trained model, built with simulated data and, possibly, other warehouse data, to the target warehouse environment. For doing so, embodiments may apply any domain adaptation methodology. Some example embodiments may assume an instance of a Domain Adversarial Neural Network Model (DANN) as an example domain adaptation approach.

### C.2 Simulation and Model Building

### C.2.1 Simulation

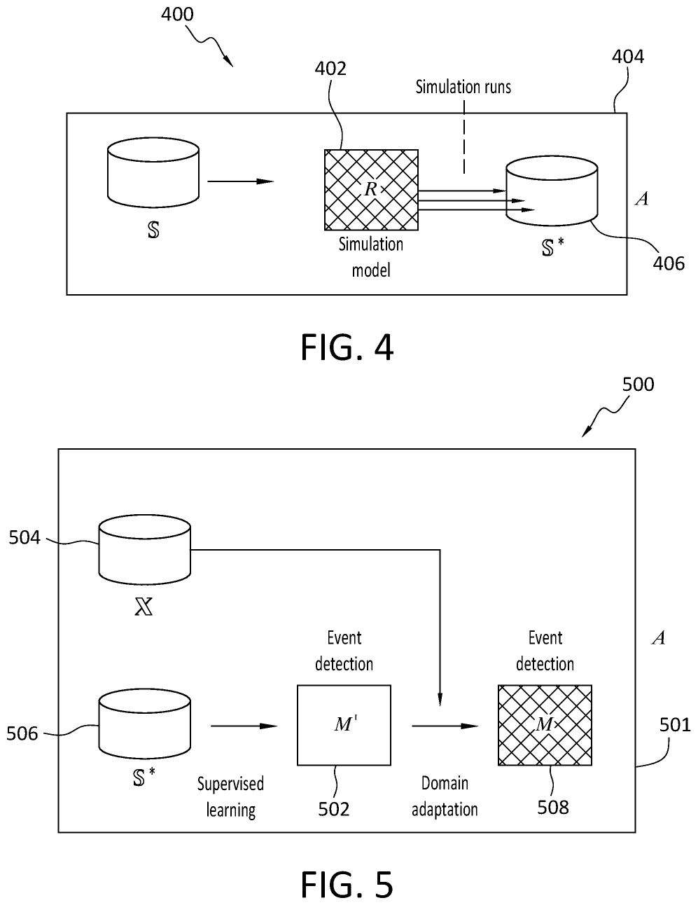

Embodiments may obtain, or create if necessary, a fitting simulation model R capable of generating synthetic data [symbol] * that is representative of the behavior of a real world domain, such as a domain where an ML model is to be deployed. The simulation, comprising the simulated data, may then be parametrized to yield synthetic data representative of particular conditions and events, such as dangerous operator behavior in the example of a forklift operator in a warehouse, without incurring the costs and risks that would arise if the data collection were to be performed in the actual environment, that is, the warehouse in this example. This is shown in FIG. 4.

Particularly, FIG. 4 discloses an example configuration 400 that includes a simulation model R 402 generated at a near-edge node A 404. The simulation model R 402 may be parametrized and exercised in simulation runs to yield synthetic data [symbol] * 406, for which known event labels may be available a priori from the parametrization model R 402. In some embodiments, Model R 402 may be obtained by leveraging domain expert knowledge and process discovery techniques, as in typical simulation approaches for other domains.

For the example domain of forklift operations in warehouse logistics, embodiments may consider that physical modeling formulations may be available from domain experts. These physical modeling formulations may comprise numerical modeling, and sets of equations, relating to detailed physical and mechanical aspects of the operation of a machine.

As examples of such simulation models, which may be employed in some embodiments of the invention, reference is now made to a multi-body system approach, with models for propulsion and tires, used for predicting forklift truck tip over. See, for example the following references: (1) P. Lemerle, O. Höppner and J. Rebelle, “Dynamic stability of forklift trucks in cornering situations: parametrical analysis using a driving simulator,” Vehicle System Dynamics, vol. 49, no. 10, pp. 1673-1693, 2011; and (2) J. Rebelle, P. Mistrot and R. Poirot, “Development and validation of a numerical model for predicting forklift truck tip-over,” Vehicle system dynamics, vol. 47, no. 7, pp. 771-804, 2009. Both the aforementioned references (1) and (2) are incorporated herein in their respective entireties by this reference.

Furthermore, a simulation model, such as the example simulation model R 402, may be informed by the data [symbol] gathered in the domain. Embodiments may deal with the problem of unsupervised learning due to the lack of labeled data in [symbol] , but some labels may be obtained. That is, some labels may be sporadically available and thus obtained, although it may be the case that not enough labels may be obtained to train a machine learning model. For example, while no labels are typically available for dangerous behavior that does not result in an accident, or other noteworthy event, when an accident is indeed detected, the data may be inspected for indications of dangerous behavior. A model may be derived, or at least fine-tuned, based on the statistical analyses of such partially available data. This latter approach may comprise a process discovery task, in which formal methods derive a simulation model fitted to some available data.

If some data and/or expert knowledge is available, a simulation model may be subject to conformance checking and enhancement iterations. For example, a domain expert, such as an expert on forklift operations for example, may determine safe ranges for observable values so that a simulation model can be tuned to generate “unsafe” behavior, and/or other behavior and conditions of interest, by extrapolating values from known trajectories, which may be collected from the available data [symbol] in the domain. In this case, the correlations between the sensor data measurements may be accounted for, and some correlated changes may need to be extrapolated, at least in the absence of reliable correlation models. In any case, a resulting simulation model R may be able to either adapt data representative of normative behavior into data representative of dangerous behavior, that is, to map from [symbol] →≈*, and/or to generate [symbol] * synthetically from physical modeling and/or numerical modeling simulations.

### C.2.2 Event Detection Model Training and Adaptation

With data [symbol] * available from a simulation model R, for which labels may be known a priori, it may then be possible to train a machine learning model M′ for event detection using a supervised learning approach. Note however, that the data [symbol] * used to train the simulation model R may be derived from a simulation, which itself carries uncertainty inherent to that simulation model fitness and accuracy to the domain, as noted earlier herein. Thus, example embodiments may adapt the resulting model M′ by leveraging the actual data [symbol] captured at a new domain via a structured domain adaptation approach. This is shown in the configuration 500, including a warehouse A 501, of FIG. 5 which discloses, in particular, the training of an event detection model M′ 502 via a supervised learning approach, and the adaptation of that model M′ 502 to additional real data [symbol] 504 such as may be gathered from a real world environment. As shown, the data [symbol] * 506 may be used to initially train the model M′ 502.

In the example of FIG. 5, the dataset [symbol] 504 may intersect with [symbol] , but may not necessarily be the same. In some cases, the dataset [symbol] 504 may comprise additional data collected from the same environment. This additional data may comprise exclusively new data, acquired after [symbol] was used to define the simulation model R. This may be particularly relevant if the simulation model R comprises a mapping function [symbol] → [symbol] *, rather than a physical or numerical modeling simulation.

Alternatively, the dataset [symbol] 504 may be collected at another environment. In this case, a dataset [symbol] may be collected from the operation of a set of forklifts E₀, E₁, . . . operating in the warehouse A 501. The domain adaptation approach using [symbol] collected from a set of forklifts F₀, F₁, . . . may then adapt the model M′ to the domain in a warehouse B.

Regardless of the adopted approach, example embodiments may assume that an applicable domain adaptation procedure is applied. Some embodiments may include the addition of a domain classifier to the original neural network M′ and training the DANN model, as disclosed elsewhere herein. In some cases at least, the input of the domain classifier may be the output of the encoder layer, such as ‘resnet50’ for example, or any arbitrary layer. Embodiments may operate to train the DANN model using [symbol] * as general (labeled) data and [symbol] as the target (unlabeled) dataset. The resulting adapted model M 508 may then be deployed to the edge nodes in the target domain for event detection inferencing. This deployment, and inferencing, may be performed as disclosed elsewhere herein.

### D. Further Discussion

As will be apparent from this disclosure, example embodiments may provide various useful features and advantages. For example, embodiments may provide a method for leveraging, for example, forklift operation simulation to build a supervised event detection ML model, which may then be fine-tuned to a target domain using a domain-adaptation technique. This approach may enable a model to be obtained using a supervised learning technique, which may then be fine-tuned for increased accuracy and precision via domain adaptation, by leveraging data collected from the actual environment in which the resulting model is, or will be, deployed.

As another example, embodiments may enable generalization of an ML model for use in other environments. To illustrate, in one embodiment of the invention the resulting intermediate event detection model M′, trained with supervised (simulated) data, may be adapted to be deployed to another environment. In this case, the gathering and orchestration processes may allow for the sharing of data across the environments. The adaptation of the model to a new environment may allow, for example, that an ML model obtained from the simulation of warehouse A be applied to the forklifts operating in warehouse B.

### E. Example Methods

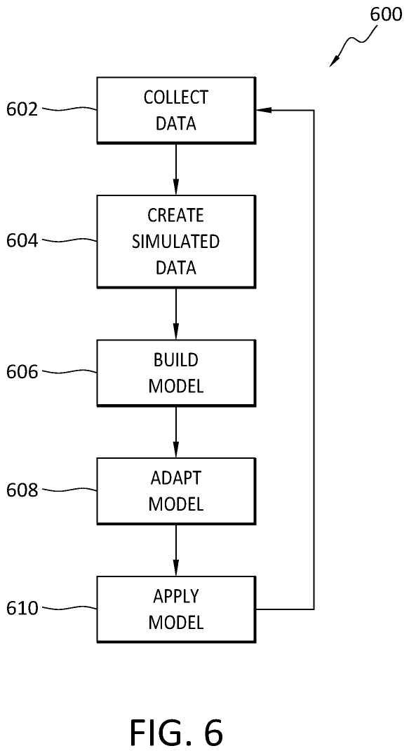

It is noted with respect to the disclosed methods, including the example method of FIG. 6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 6, an example method 600 may begin with the collection of data 602 from a real world operating environment. The data may comprise, for example, data concerning the operation of equipment in a warehouse. The data may be collected by any suitable sensor(s), examples of which include, but are not limited to, video cameras. The data collected at 602 may comprise unlabeled data.

Next, a simulator may be used to create simulated, or synthetic, data 604 based on the data that was collected at 602. The simulated data may comprise, for example, data about specific events of interest, such as unsafe forklift operation for example, that are not necessarily reflected in the data collected at 602. The simulated data may comprise labeled data.

The simulated data that was created 604 may then be used to build a machine learning model 606. The ML model may be configured, for example, to detect one or more particular events of interest, and/or to generate warnings, such as to an equipment operator for example, when an event of interest is detected, or predicted to occur.

In at least some instances, the ML model that was created at 606 may benefit from fine tuning. Thus, the ML model may be adapted 608 using, for example, some of the data that was collected at 602. In this way, the ML model may be made suitable for use in the environment from which the data was collected 602. Note, however, that the model may be adapted 608 for use in an environment different from that from which the data was collected 602.

In either case, after the ML model has been adapted, or fine-tuned, the model may then be applied 610 to the target environment of interest which, as just noted, may or may not be the environment from which the real world data was collected 602. Application of the ML model 610 may comprise deployment, such as from a near-edge node or central node, of the adapted model to one or more edge devices, examples of which include, but are not limited to, equipment such as forklifts that include sensors that are operable to gather and/or generate data concerning an environment where the edge device(s) is/are located, and/or operate. The edge devices may, or may not, be able to communicate with each other. Further, the edge devices may communicate with a near-edge node, or central node, where the ML model is created 606 and refined 610.

### F. Further Example Embodiments

Following are some further example embodiments of the invention. These are presented only by way of example and are not intended to limit the scope of the invention in any way.

Embodiment 1. A method, comprising: collecting data regarding operations of equipment in an operating environment; using the collected data to create simulated data; using the simulated data to build a model that is operable to detect an event of interest that relates to the equipment; using the collected data to refine the model; and applying the model in a target environment, wherein applying the model comprises deploying the model to equipment operating in a target environment.

Embodiment 2. The method as recited in embodiment 1, wherein the data is collected by one or more sensors in the operating environment.

Embodiment 3. The method as recited in any of embodiments 1-2, wherein the model is operable to predict occurrence of the event of interest.

Embodiment 4. The method as recited in any of embodiments 1-3, wherein the operating environment and the target environment are the same environment.

Embodiment 5. The method as recited any of embodiments 1-3, wherein the operating environment and the target environment are different respective environments.

Embodiment 6. The method as recited in any of embodiments 1-5, wherein the data comprises any one or more of: video data; positioning data regarding one or more locations of the equipment; or, data regarding the operation of the equipment.

Embodiment 7. The method as recited in any of embodiments 1-6, wherein the equipment comprises one of a group of edge devices that operate in the operating environment.

Embodiment 8. The method as recited in any of embodiments 1-7, wherein the model is created and refined at a near-edge node with which an edge node associated with the equipment is operable to communicate.

Embodiment 9. The method as recited in any of embodiments 1-8, wherein the model comprises a supervised machine learning model.

Embodiment 10. The method as recited in any of embodiments 1-9, wherein the simulated data comprises simulated operations of the equipment.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

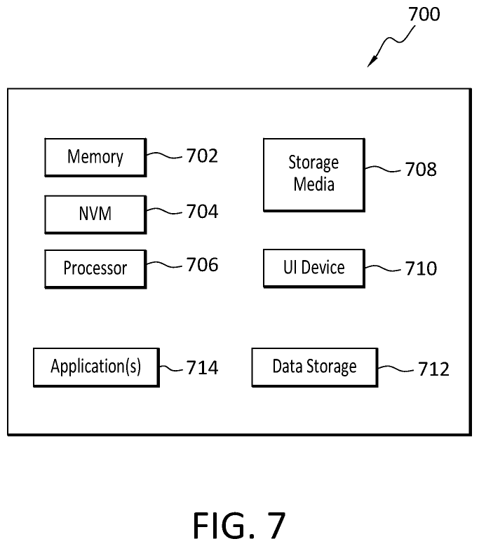

With reference briefly now to FIG. 7, any one or more of the entities disclosed, or implied, by FIGS. 1-6 and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 6.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI (user interface) device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
collecting data regarding operations of equipment in an operating environment;
using the collected data to create simulated data;
using the simulated data to build a model that is operable to detect an event of interest that relates to the equipment;
using the collected data to refine the model; and
applying the model in a target environment, wherein applying the model comprises deploying the model to equipment operating in a target environment.

2. The method as recited in claim 1, wherein the data is collected by one or more sensors in the operating environment.

3. The method as recited in claim 1, wherein the model is operable to predict occurrence of the event of interest.

4. The method as recited in claim 1, wherein the operating environment and the target environment are the same environment.

5. The method as recited in claim 1, wherein the operating environment and the target environment are different respective environments.

6. The method as recited in claim 1, wherein the data comprises any one or more of: video data; positioning data regarding one or more locations of the equipment; or, data regarding the operation of the equipment.

7. The method as recited in claim 1, wherein the equipment comprises one of a group of edge devices that operate in the operating environment.

8. The method as recited in claim 1, wherein the model is created and refined at a near-edge node with which an edge node associated with the equipment is operable to communicate.

9. The method as recited in claim 1, wherein the model comprises a supervised machine learning model.

10. The method as recited in claim 1, wherein the simulated data comprises simulated operations of the equipment.

11. A non-transitory storage medium having stored therein instructions that are executable by one or more hardware processors to perform operations comprising:
collecting data regarding operations of equipment in an operating environment;
using the collected data to create simulated data;
using the simulated data to build a model that is operable to detect an event of interest that relates to the equipment;
using the collected data to refine the model; and
applying the model in a target environment, wherein applying the model comprises deploying the model to equipment operating in a target environment.

12. The non-transitory storage medium as recited in claim 11, wherein the data is collected by one or more sensors in the operating environment.

13. The non-transitory storage medium as recited in claim 11, wherein the model is operable to predict occurrence of the event of interest.

14. The non-transitory storage medium as recited in claim 11, wherein the operating environment and the target environment are the same environment.

15. The non-transitory storage medium as recited in claim 11, wherein the operating environment and the target environment are different respective environments.

16. The non-transitory storage medium as recited in claim 11, wherein the data comprises any one or more of: video data; positioning data regarding one or more locations of the equipment; or, data regarding the operation of the equipment.

17. The non-transitory storage medium as recited in claim 11, wherein the equipment comprises one of a group of edge devices that operate in the operating environment.

18. The non-transitory storage medium as recited in claim 11, wherein the model is created and refined at a near-edge node with which an edge node associated with the equipment is operable to communicate.

19. The non-transitory storage medium as recited in claim 11, wherein the model comprises a supervised machine learning model.

20. The non-transitory storage medium as recited in claim 11, wherein the simulated data comprises simulated operations of the equipment.
